(19) United States
(12) Patent Application Publication
(10) Pub. No.: US 2012/0327199 A1
(43) Pub. Date: Dec. 27, 2012

(54) AUTOSTEREOSCOPIC DISPLAY WITH MODULATING SCREEN HAVING MULTIPLE SECTIONAL IMAGES

(75) Inventors: Cheng-Huan Chen, Taoyuan County (TW); Chao-Hsu Tsai, Hsinchu City (TW); Chang-Shuo Wu, New Taipei City (TW); Chang-Ying Chen, Kaohsiung City (TW)

(73) Assignee: INDUSTRIAL TECHNOLOGY RESEARCH INSTITUTE, Hsinchu (TW)

(21) Appl. No.: 13/565,820

(22) Filed: Aug. 3, 2012

Related U.S. Application Data
(63) Continuation-in-part of application No. 12/269,869, filed on Nov. 12, 2008.

(30) Foreign Application Priority Data
Jan. 28, 2008 (TW) 97103087

(51) Int. Cl. H04N 13/04; G02B 27/22

(52) U.S. Cl. 348/51; 353/7

(57) ABSTRACT

An autostereoscopic displaying unit is for displaying an image, which includes a plurality of viewing-zone images corresponding to a plurality of viewing zones. The autostereoscopic displaying unit includes a viewing zone adjusting module for adjusting a content of each pixel of the image corresponding to a determined one of the viewing zones according to a viewing-zone shifting information. The viewing-zone shifting information includes a viewing-zone correction for distortion of a projection lens, and the image is then modified as an adjusted image. A projection module with the projection lens projects the adjusted image. A viewing zone modulating screen receives and displays the adjusted image.

### CROSS-REFERENCE TO RELATED APPLICATION

This application is a continuation-in-part application of and claims the priority benefit of a prior application Ser. No. 12/269,869, filed on Nov. 12, 2008, now pending. The prior application Ser. No. 12/269,869 claims the priority benefit of Taiwan application Ser. No. 97103087, filed on Jan. 28, 2008. The entirety of each of the above-mentioned patent applications is hereby incorporated by reference herein and made a part of this specification.

### TECHNICAL FIELD

The present disclosure relates to an autostereoscopic display with integrated projection array.

### BACKGROUND

According to the visualization characteristic of human naked eyes, when the left eye and the right eye of a viewer respectively look at two images of the same object or scene but with different parallaxes from each other, a stereo image is sensed by the viewer, which is just the basic principle of stereo display. The stereo presentation in the earlier days is produced by taking advantage of the polarized light effect, i.e. to output two images in different polarization directions and let a viewer wearing a pair of polarized glasses so as the left and right eyes to respectively receive the images with corresponding parallax.

After then, autostereoscopic display technologies on which viewers don't need to wear any extra eye-ware to watch stereo images are developed based on the technology of digital display. In terms of projection-type display technology, a plurality of projectors is used to respectively project an image corresponding to an assigned viewing zone. FIG. 1 is a diagram illustrating a conventional projection-type autostereoscopic display technology. Referring to FIG. 1, a plurality of image projectors 50 respectively projects an image corresponding to a viewing zone. Then, the projected images respectively strike the left-right eyes of a viewer 56 by means of a field lens 52 to construct a stereo image, wherein a light diffusion plate 54 is employed to lighten unevenness on the screen.

In the projection system of the 3-D display, the field lens 52 is usually formed by one or several Fresnel lenses to achieve an autostereoscopic display with multiple viewing zones function in association of the image projectors 50. The number of the image projector 50 is equal to the number of the viewing zones, and the viewable resolution of each the viewing zone is the resolution of the projector.

A sufficient projection distance is required for each projector to project an image onto the whole screen in such a system. In fact, the larger the screen size, the longer the required distance is and the larger the system volume is. When tens or hundreds of viewing zones are required, it is very possible that the internal space of the system is not enough to accommodate the projectors of the corresponding sufficient number. Since a field lens 54 possesses a certain focal length; and the longer the required focal length (depending on the projection distance), the larger the dimension of the field lens is, therefore, the system must be voluminous. In particular, the larger the screen, the system volume grows rapidly.

### SUMMARY

Accordingly, the present disclosure is directed to an autostereoscopic display, which is able to keep a smaller volume and maintain the good stereo display effect for an increasing screen size and an increasing number of viewing zones.

In addition, the lens distortion effect due to projection lens can be modified back or reduced.

In an exemplary embodiment of disclosure, an autostereoscopic displaying unit is for displaying an image, which includes a plurality of viewing-zone images corresponding to a plurality of viewing zones. The autostereoscopic displaying unit includes a viewing zone adjusting module for adjusting a content of each pixel of the image corresponding to a determined one of the viewing zones according to a viewing-zone shifting information. The viewing-zone shifting information includes a viewing-zone correction for distortion of a projection lens, and the image is then modified as an adjusted image. A projection module with the projection lens projects the adjusted image. A viewing zone modulating screen receives and displays the adjusted image.

In an exemplary embodiment of disclosure, an autostereoscopic displaying unit for displaying an image includes a group of the micro-projection modules, respectively projecting a group of viewing-zone images corresponding to a plurality of viewing angles. A viewing zone modulating screen receives and displays the viewing-zone images corresponding to the viewing angles. The viewing zone modulating screen comprises a first lenticular plate; a second lenticular plate; and an imaging layer between the first lenticular plate and the second lenticular plate. The first lenticular plate focuses and aligns pixels of the viewing-zone images onto the imaging layer with respect to the second lenticular plate, and the second lenticular plate deflects the viewing-zone images onto the specific viewing angles.

### BRIEF DESCRIPTION OF THE DRAWINGS

The accompanying drawings are included to provide a further understanding of the disclosure, and are incorporated in and constitute a part of this specification. The drawings illustrate exemplary embodiments, together with the description, serve to explain the principles of the disclosure.

FIG. 1 is a diagram illustrating a conventional projection-type autostereoscopic display technology.

FIG. 2 is a 3-D structure diagram of an integrated-projection-array autostereoscopic display where the distribution images are tightly joined according to an exemplary embodiment.

FIG. 3 is a 3-D structure diagram of an integrated-projection-array autostereoscopic display where the distribution images are partially-overlapping joined according to an exemplary embodiment.

FIG. 4 is a top view diagram of an autostereoscopic display taking the 2×2 array of FIG. 2 as an example.

FIG. 5 is a side view diagram of an autostereoscopic display taking the 2×2 array of FIG. 2 as an example.

FIG. 6 is a structure diagram of a viewing zone modulating screen according to an exemplary embodiment.

FIG. 7 is a diagram showing how images for different viewing zones are produced by using the viewing zone modulating screen 110a of FIG. 6.

FIG. 8 is a structure diagram of a viewing zone modulating screen according to another exemplary embodiment.

FIG. 9 is a diagram showing how images for different viewing zones are produced by using the viewing zone modulating screen 110b of FIG. 8.

FIG. 10 is a diagram showing the relative placing angle between a viewing zone modulating screen and micro-projection modules.

FIG. 11 is a distribution diagram of the pixels and their corresponding viewing zones on a sectional image according to an exemplary embodiment.

FIG. 12 is a diagram showing the placing angle of a lens array of a viewing zone modulating screen according to an exemplary embodiment.

FIG. 13 is a diagram showing the relative placing angle of a parallax barrier layer of a viewing zone modulating screen according to an exemplary embodiment.

FIG. 14 is a diagram showing the relative placing angle between a viewing zone modulating screen and micro-projection modules.

FIG. 15 is a distribution diagram of the pixels and their corresponding viewing zones on a sectional image according to an exemplary embodiment.

FIG. 16 is a distribution diagram of the pixels and their corresponding viewing zones on a sectional image according to an exemplary embodiment.

FIG. 17 is a distribution diagram of the pixels and their corresponding viewing zones on a sectional image according to an exemplary embodiment.

FIG. 18 is a drawing, schematically illustrating distortion effect due to projection lens considered in the disclosure.

FIG. 19 is a drawing, schematically illustrating a relation between pixel locations on the lenticular plate and viewing zones, according to an exemplary embodiment.

FIG. 20 is a drawing, schematically illustrating a distortion effect between pixel locations on the lenticular plate and viewing zones, according to an exemplary embodiment.

FIG. 21 is a drawing, schematically illustrating a distortion effect between pixel locations on the lenticular plate and viewing zones at a plane view, according to an exemplary embodiment.

FIG. 22 is a drawing, schematically illustrating a distortion effect between pixel locations on the lenticular plate and viewing zones at a plane view, according to an exemplary embodiment, where the lenticular plate is slanted.

FIG. 23 is a drawing, schematically illustrating a sampling array on the screen for detecting viewing-zone shift, according to an exemplary embodiment.

FIG. 24 is a perspective drawing, schematically a mechanism for detecting the viewing-zone shift, according to an exemplary embodiment.

FIG. 25 is a drawing, schematically illustrating a sample image for detecting the viewing-zone shift, according to an exemplary embodiment.

FIG. 26 is a drawing, schematically illustrating a result on a sampling point with the viewing-zone shift, according to an exemplary embodiment.

FIG. 27 is a drawing, schematically illustrating estimation of viewing-zone shift for the pixel based on interpolation from the sampling point, according to an exemplary embodiment.

FIG. 28 is a drawing, schematically illustrating a projection display unit with lens correction, according to an exemplary embodiment.

FIG. 29 is a drawing, schematically illustrating a projection display unit, according to an exemplary embodiment.

FIG. 30 is a drawing, schematically illustrating a projection display system, to form a larger screen size, according to an exemplary embodiment.

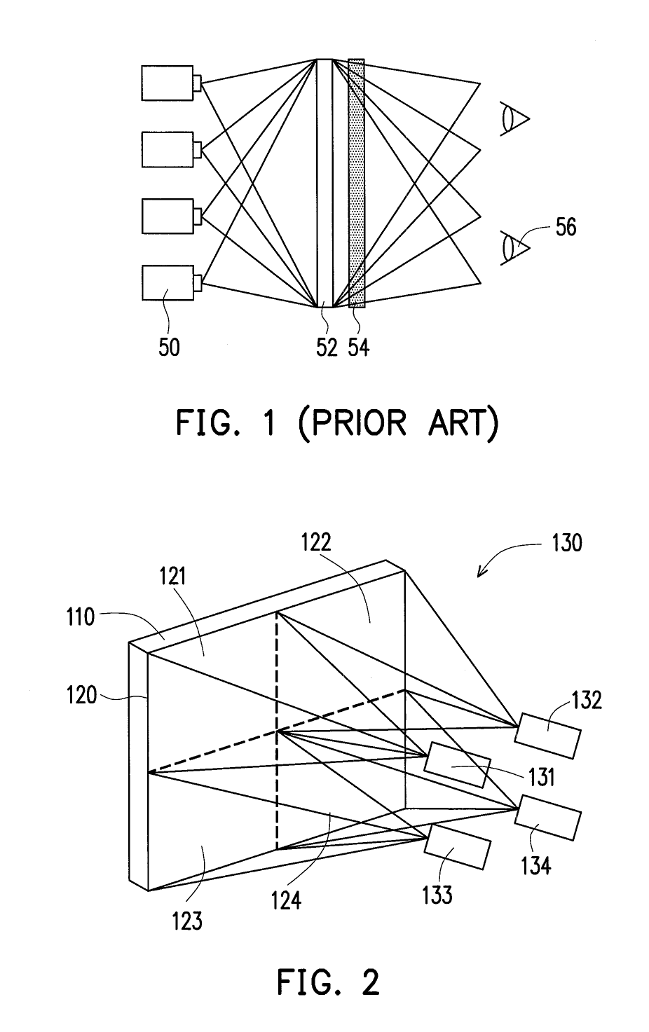

### DETAILED DESCRIPTION OF DISCLOSED EMBODIMENTS

Reference will now be made in detail to the present embodiments of the disclosure, examples of which are illustrated in the accompanying drawings. Wherever possible, the same reference numbers are used in the drawings and the description to refer to the same or like parts.

In the provided embodiments, the stereo display effect is achieved by using projection module array. Each of the micro-projection modules projects a sectional image having multiple images at different viewing angles. The viewing zone modulating screen can be, for example, a lenticular array or a parallax barrier plate for achieving the desired 3-D display effect; however, the present disclosure is not limited to the above-mentioned two designs. A plurality of projection modules respectively projects a sectional image of a 3-D image formed by combining a plurality of images in different viewing-angles, so that a 3-D image with a desired size and resolution can be realized by joining the projected sectional images.

FIG. 2 is a 3-D structure diagram of an autostereoscopic display. Referring to FIG. 2, an autostereoscopic display system includes, for example, an array 130 composed of a plurality of projection modules 131-134 and a viewing zone modulating screen 110 having the function of directing pixel images to corresponding viewing zones. The number of the projection modules can be four as the example to form a 2×2 array. However, the present disclosure does not limit the manner of forming the array of the projection modules, the number of the modules and the size of each module; for example, the array can also be an one-dimensional array.

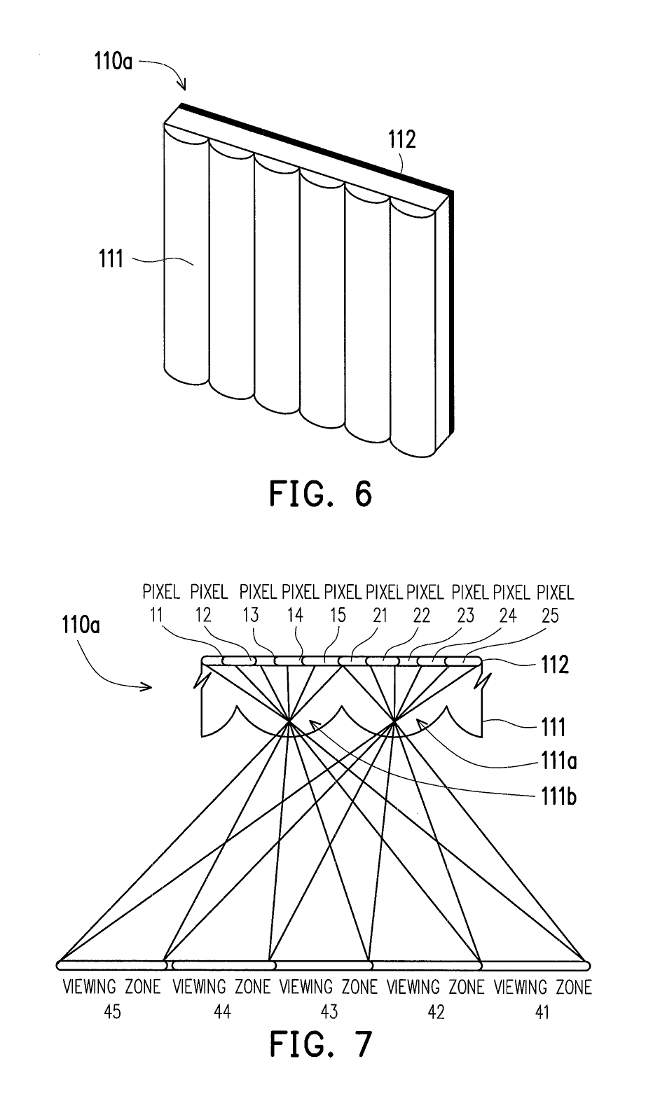

The projection module array 130 of the present disclosure is for combining the images of the projection modules 131-134 to construct a complete image. The viewing zone modulating screen of the autostereoscopic display is for guiding each pixel of the images to a corresponding viewing zone so as to establish a 3-D display image with a plurality of viewing zones and having a high resolution for each the viewing zone. Each of the projection modules 131-134 of the projection module array 130 is respectively in charge of displaying each of the sectional images 121-124 on a region of the complete image so as to form the imaging on a partial region of the viewing zone modulating screen 110. The projected images produced by all the projection modules 131-134 of the projection module array 130 are jointed into a complete image 120 on the viewing zone modulating screen 110, wherein the complete image 120 contains the images of different viewing angles corresponding to different viewing zones. The viewing zone modulating screen 110 then guides each pixel image to a corresponding viewing zone position in front of the screen (FIGS. 6 and 7), so that a viewer can see the images with different viewing-angles through the left-right eyes and see the 3-D image with a stereo effect.

When the viewer moves, since there are still other viewing zones at the side of the viewer corresponding to different view angle, thus, the viewer is able to see not only a 3-D image, but also other 3-D images with different viewing-angles depending on the viewing zone where the viewer is located. This manner has the motion parallax function.

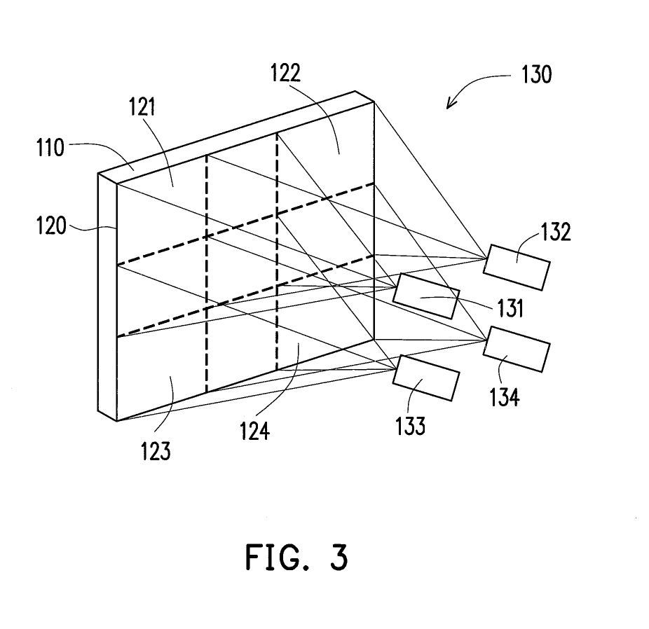

The sectional images 121-124 of all the projection modules can be tightly joined as shown in FIG. 2 or partially overlapping joined as shown in FIG. 3, wherein the partially overlapping joining way can eliminate the seam trace between two adjacent sectional images.

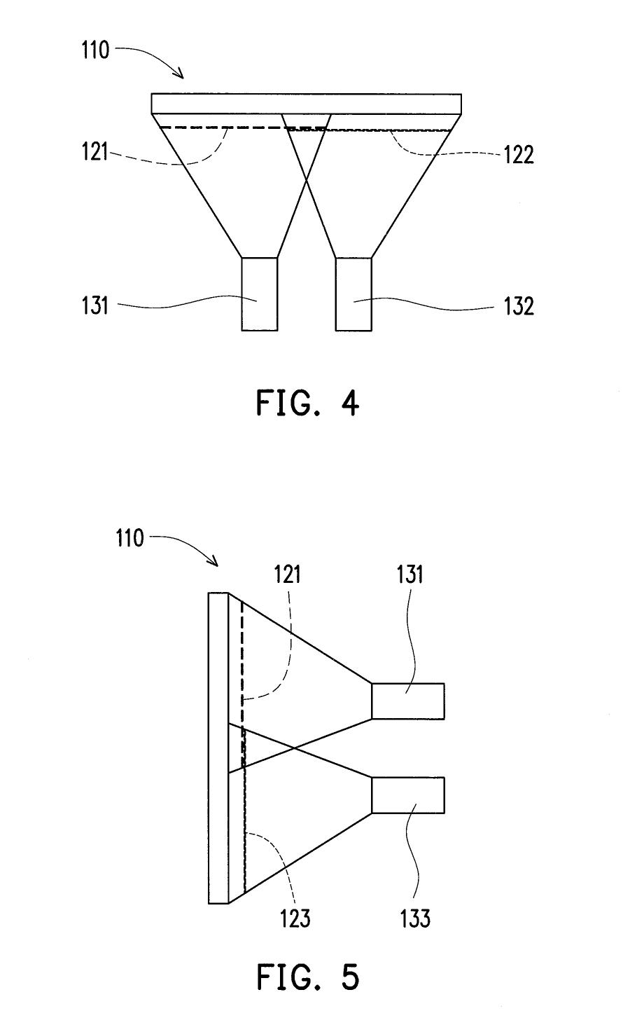

FIG. 4 is a top view diagram of an autostereoscopic display taking the 2×2 array of FIG. 2 as an example. Referring to FIG. 4, two sectional images 121 and 122 produced by the projection modules 131 and 132 are, for example, partially overlapped on the viewing zone modulating screen 110. FIG. 5 is a side view diagram of an autostereoscopic display taking the 2×2 array of FIG. 2 as an example. Referring to FIG. 5, similarly to FIG. 4, two sectional images 121 and 123 produced by the projection modules 131 and 133 are, for example, partially overlapped on the viewing zone modulating screen 110 as well.

FIG. 6 is a structure diagram of a viewing zone modulating screen according to an exemplary embodiment Referring to FIG. 6, a viewing zone modulating screen 110a is formed by, for example, a viewing zone modulating layer 111 and an imaging layer 112 (for example, a light diffusing layer). The viewing zone modulating layer 111 is, for example, a lenticular array 111 which has a plurality of micro cylinder structures on a side thereof and the cylinder structures are arranged, for example, in parallel. In the embodiment, the cylinder surfaces are extended in, for example, the vertical direction. The imaging layer 112 (for example, a light diffusing layer) is disposed on a flat surface opposite to the side of the cylinder structures and faces the projection modules.

The imaging principle is depicted in the following. FIG. 7 is a diagram showing how images for different viewing zones are produced by using the viewing zone modulating screen 110a of FIG. 6. Referring to FIG. 7, the images projected by the projection modules 131-134 are images on the imaging layer 112 (for example, a light diffusing layer)1 behind the lenticular array 111. The number of horizontal pixels corresponding to a lenticular element 111a or 111b is just the number of viewing zones. The embodiment of FIG. 7 has, for example but not limited to by the present disclosure, five viewing zones. Among the pixel images on a complete image combined by a plurality of sectional images, every five longitudinal pixel images columns are counted as a set, and each set of the pixel images is corresponding to a lenticular element, wherein the five pixel images columns 11-15 of the first set are respectively projected onto different viewing zones 41-45 through, for example, the lenticular element 111b, and the five pixel images columns 21-25 of the second set are respectively projected onto different viewing zones 41-45 as well through, for example, the lenticular element 111a. The pixel images of each set on the image are corresponding to a lenticular element and are respectively projected onto the different viewing zones 41-45 through a lenticular element. An eye located at a viewing zone would see an image of a viewing-angle corresponding to the viewing zone. When the left-right eyes of a viewer are located at two different viewing zones, a stereo image effect is established.

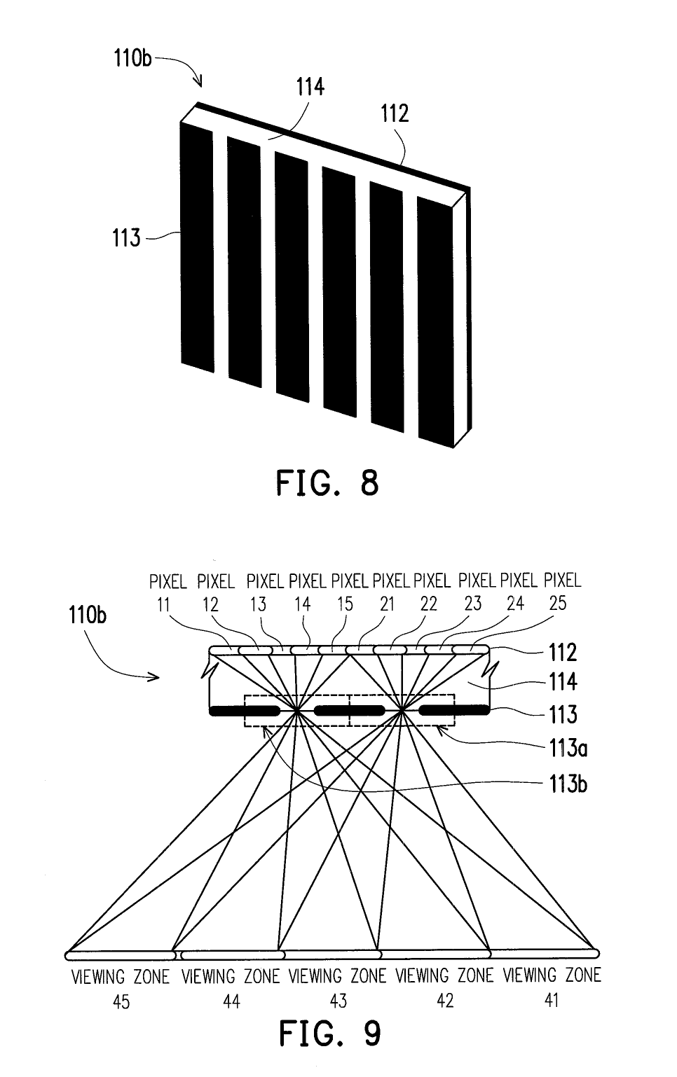

In terms of respectively producing different images for different viewing zones, the design of FIG. 6 is not an exclusive design. FIG. 8 is a structure diagram of a viewing zone modulating screen according to another exemplary embodiment. Referring to FIG. 8, the viewing zone modulating layer of a viewing zone modulating screen 110b includes, for example, a transparent layer 114 and a parallax barrier layer 113. A plurality of opaque stripe-like regions is disposed on the transparent layer 114 so as to form a grating structure arranged in parallel with an interval between two adjacent grating stripes. An imaging layer 112 is disposed on another side of the transparent layer 114, and the imaging layer 112 is, for example, a light diffusing layer. The transparent layer 114 can be composed of air or any transparent material.

FIG. 9 is a diagram showing how images for different viewing zones are produced by using the viewing zone modulating screen 110b of FIG. 8. Referring to FIG. 9, the images projected by the projection modules 131-134 are images on the imaging layer 112 (for example, a light diffusing layer) behind the transparent layer 114. The number of horizontal pixels corresponding to a parallax barrier element 113a or 113b is just the number of viewing zones. The embodiment of FIG. 9 has, for example but not limited to by the present disclosure, five viewing zones. Among the pixel images on a complete image combined by a plurality of sectional images, every five longitudinal pixel images columns are counted as a set, and each set of the pixel images is corresponding to a parallax barrier element, wherein the five pixel images columns 11-15 of the first set are respectively projected onto different viewing zones 41-45 through, for example, the parallax barrier element 113b, and the five pixel images columns 21-25 of the second set are respectively projected onto different viewing zones 41-45 as well as through, for example, the parallax barrier element 113a. The pixel images of each set on the image are corresponding to a parallax barrier element and are respectively projected onto the different viewing zones 41-45 through a parallax barrier element. An eye located at a viewing zone would see an image of a viewing-angle corresponding to the viewing zone. When the left-right eyes of a viewer are located at two different viewing zones, a stereo image effect is established.

The above-described two types of viewing zone modulating screens are intended to guide the pixel images in the horizontal direction to different viewing zones. This method may induce resolution unbalance between horizontal and vertical directions, for example, at each viewing zone, a viewer may see an image with a higher vertical resolution and a lower horizontal resolution. Multiple schemes in the following are taken to improve the evenness of the vertical and horizontal resolutions.

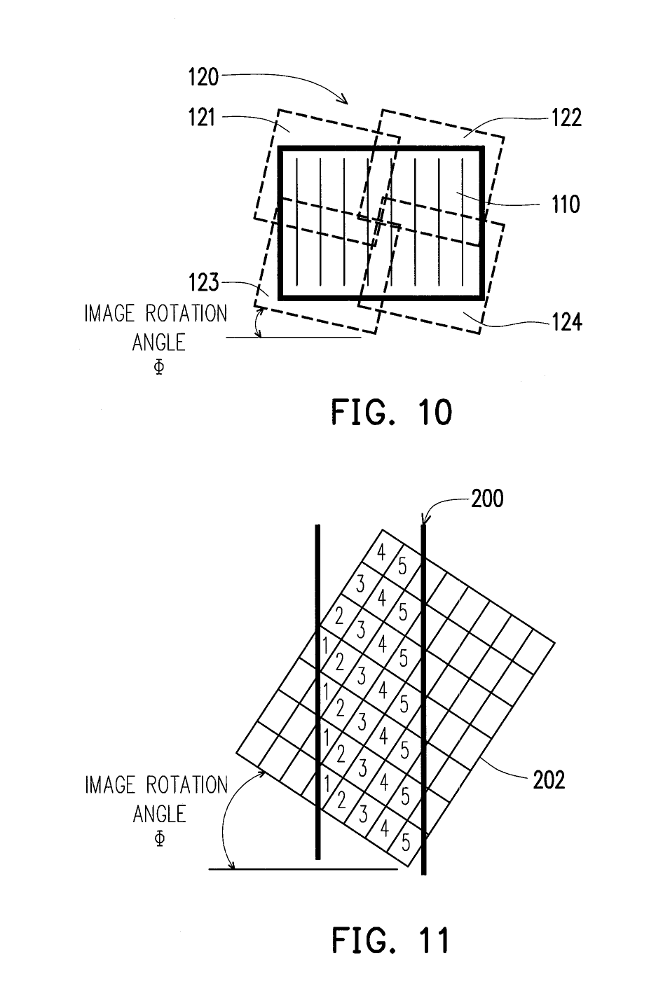

FIG. 10 is a diagram showing the relative placing angle between a viewing zone modulating screen and projection modules. Referring to FIG. 10, taking the configuration of FIG. 2 as an example, a viewing zone modulating screen 110 possesses a horizontal reference direction and a vertical reference direction. A complete image 120 is composed of sectional images 121-124, wherein the sectional images 121-124 are oriented relatively to the horizontal reference direction in an image rotation angle Φ and the rotation angle Φ in the embodiment is greater than zero. In addition, the strip direction on the viewing zone modulating screen 110, i.e. the extension direction of the cylinder lenses or the opaque barrier stripes are the same as the vertical reference direction, so that the sectional images have a rotation angle Φ relatively to the viewing zone modulating screen 110.

FIG. 11 is a distribution diagram of the pixel images and the viewing zones on a sectional image according to an exemplary embodiment. Referring to FIG. 11, one of the sectional images 121-124 shown in FIG. 10 is taken for the depiction. The stripes 200 of the viewing zone modulating screen 110 are in the vertical direction and the pixel images array 202 on the sectional image is oriented in a rotation angle Φ relatively to the horizontal reference direction. The pixel images array 202 on the sectional image is the images for five viewing zones, for example, the regions 1-5; therefore, there are five viewing zones between two the adjacent stripes 200.

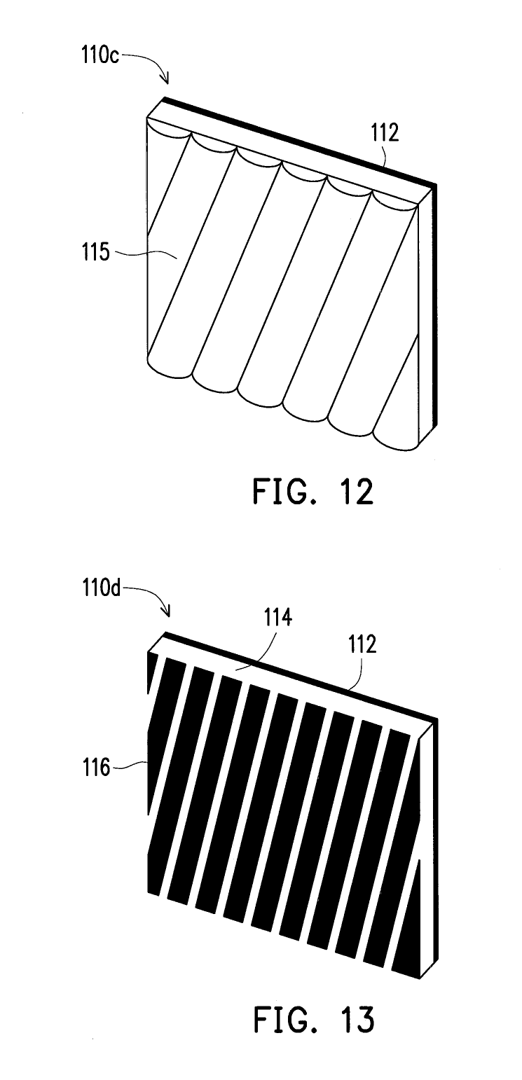

FIG. 12 is a diagram showing the placing angle of a lens array of a viewing zone modulating screen according to an exemplary embodiment. Referring to FIG. 12, the viewing zone modulating screen 110c in FIG. 12 is similar to the viewing zone modulating screen 110a in FIG. 6 except that the lenticular array 115 in FIG. 12 is oriented not in the vertical direction, but in a bevel angle relatively to the vertical reference direction and the bevel angle is termed as screen tilting angle or screen bevel angle. FIG. 13 is a diagram showing the relative placing angle of a parallax barrier layer of a viewing zone modulating screen according to an exemplary embodiment. Referring to FIG. 13, the viewing zone modulating screen 110d in FIG. 13 is similar to the viewing zone modulating screen 110b in FIG. 8 except that the parallax barrier layer 116 in FIG. 13 is oriented not in the vertical direction, but in a screen tilting angle.

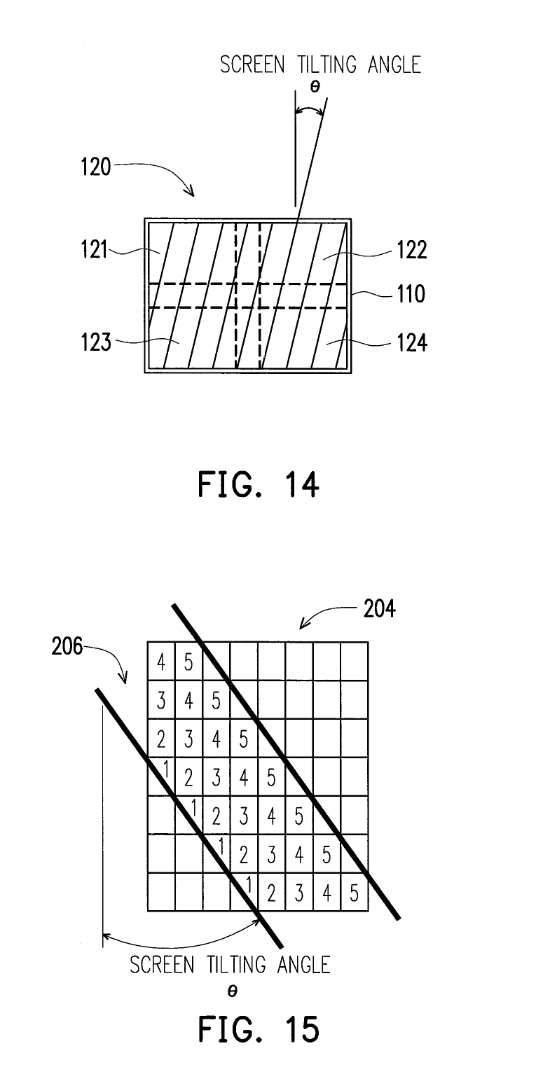

FIG. 14 is a diagram showing the relative placing angle between a viewing zone modulating screen and projection modules. Referring to FIG. 14, the viewing zone modulating screen herein is that of FIG. 12 or FIG. 13, thus, the sectional images 121-124, for example, do not need a rotation, i.e., the rotation angle Φ herein is zero, but the screen tilting angle θ relatively to the vertical reference direction is equal to a non-zero preset value.

FIG. 15 is a distribution diagram of the pixel images and the viewing zones on a sectional image according to an exemplary embodiment. Referring to FIG. 15, one of the sectional images 121-124 shown in FIG. 14 is taken for the depiction. The stripes 206 of the viewing zone modulating screen 110 are oriented in a non-zero screen tilting angle θ relatively to the vertical reference direction and the pixel images array 204 on the sectional image is oriented in a rotation angle Φ of zero relatively to the horizontal reference direction, i.e. there is no rotation at all. The pixel images array 204 on the sectional image is the images for five viewing zones, for example, the regions 1-5; therefore, there are five viewing zones between two the adjacent stripes 206.

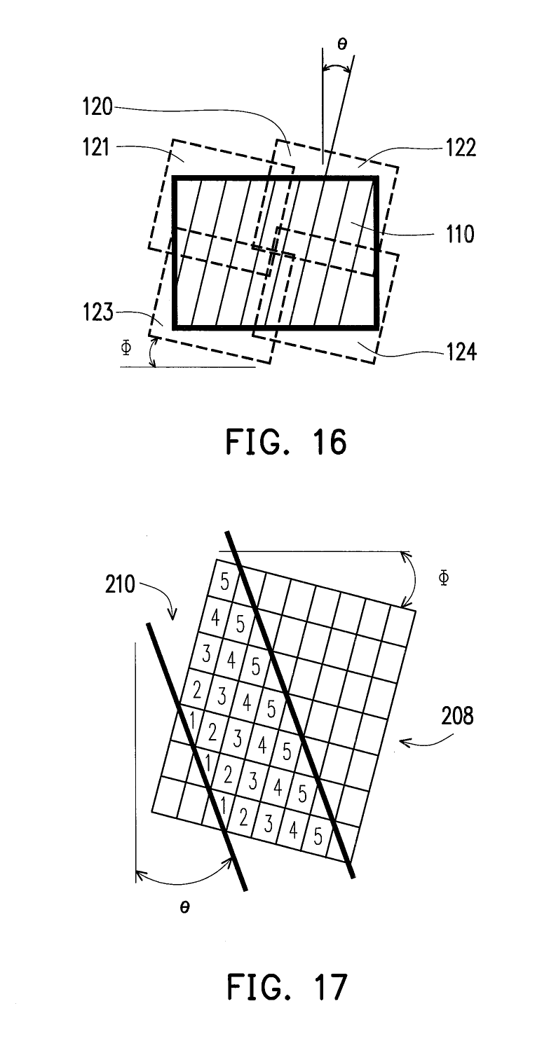

FIG. 16 is a distribution diagram of the pixel images and the viewing zones on a sectional image according to an exemplary embodiment. Referring to FIG. 16, the configuration herein is that both of the stripes 206 of the viewing zone modulating screen 110 and the sectional images 121-124 have rotations. That is to say, both of the rotation angle Φ and the screen tilting angle θ are not zero. FIG. 17 is a distribution diagram of the pixel images and the viewing zones on a sectional image according to an exemplary embodiment. Referring to FIG. 17, the configuration herein is that of FIG. 16, i.e., the stripes 210 of the viewing zone modulating screen has a non-zero screen tilting angle θ relatively to the vertical reference direction. The pixel images array 206 on the sectional image has a non-zero rotation angle Φ relatively to the horizontal reference direction, i.e. has a rotation. The pixel images array 208 on the sectional image is the images for five viewing zones, for example, the regions 1-5; therefore, there are five viewing zones between two in the adjacent stripes 210.

It can be seen from the above described, the configurations according to the different embodiments can be that both of the rotation angle Φ and the screen tilting angle θ are zero, or one of the rotation angle Φ and the screen tilting angle θ is zero but the another one is not zero, or both of the rotation angle Φ and the screen tilting angle θ are not zero.

As to the viewing zone modulating layer of the viewing zone modulating screen can be a cylinder lenses array, or a grating structure with a parallax barrier effect, or other optical components with a stereo display effect, which the present disclosure is not limited to.

In further considering the distortion effect due to projection lens, the viewing zone for the pixels may need to be corrected.

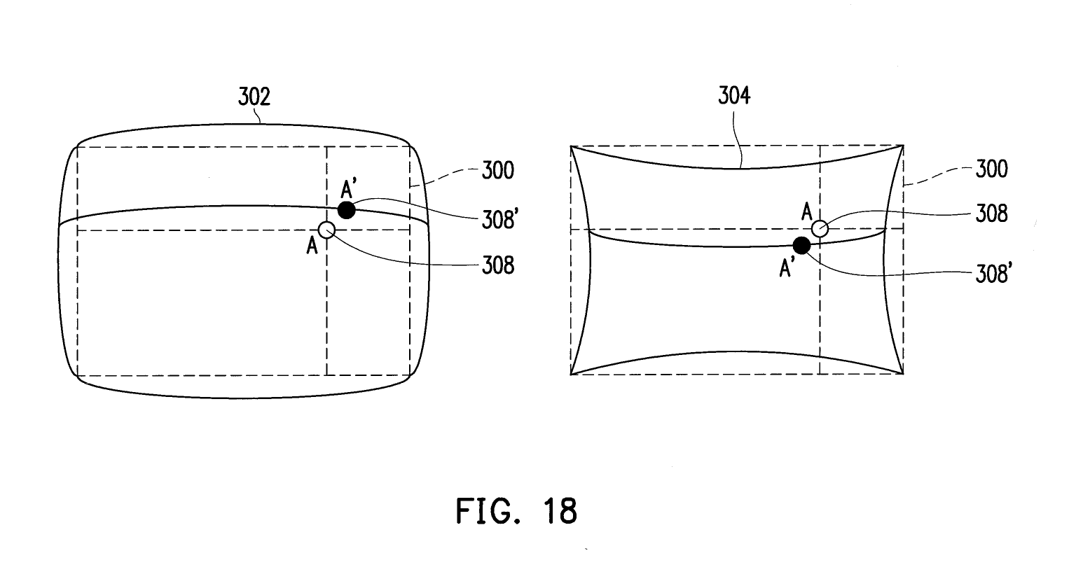

FIG. 18 is a drawing, schematically illustrating distortion effect due to projection lens considered in the disclosure. In FIG. 18, the projection module usually has a projection lens to project the image to the screen. A viewing zone modulating screen 300 usually has the rectangular shape. However, the projection lens with the needed focusing power may distort the ideal image with expansion as shown in left drawing or shrinkage as shown in right drawing. A pixel 308 of the ideal image ideally located at location A of the screen 300 is then shifted to the pixel 308′ at location A′ of the screen 300 due to image distortion. If the shift of the pixel is over large, the supposed viewing zones at the pixel 308 and the pixel 308′ may not be consistent. This would cause defect of the stereo vision.

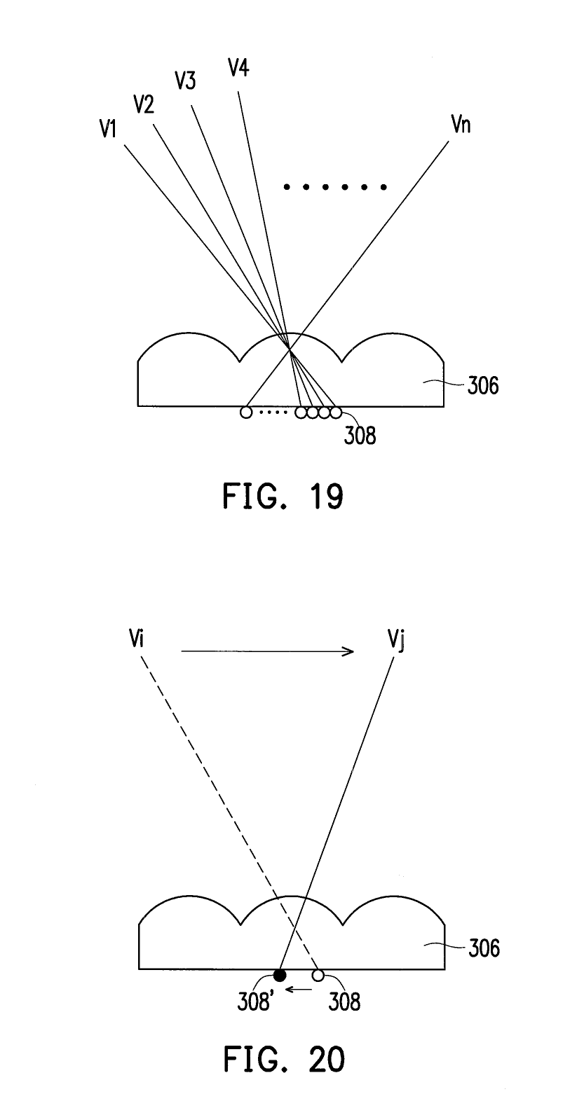

FIG. 19 is a drawing, schematically illustrating a relation between pixel locations on the lenticular plate and viewing zones, according to an exemplary embodiment. The relation of viewing zones V1, V2, V3, V4, . . . Vn and the locations of the pixels 308 with respect to lenticular plate 306 is shown in better detail. Each cylindrical lens of the lenticular plate is corresponding to a group of the pixels 308 belonging to different viewing zones. Due to the different locations of the pixels 308, the pixels 308 is projected to a viewing angle corresponding to viewing zones V1, V2, V3, V4, . . . Vn. As previously described, the image contents between the different viewing zones have a parallax as designed.

FIG. 20 is a drawing, schematically illustrating a distortion effect between pixel locations on the lenticular plate and viewing zones, according to an exemplary embodiment. In FIG. 20 with the distortion effect in FIG. 18, the pixel 308 is distorted as the pixel 308′ with a shift as indicated by arrow. This shift would move the pixel 308 to the pixel 308′. The location of the pixel 308 is ideally assigned to be protected to the viewing zone Vi and the location of the pixel 308′s is ideally assigned to be protected to the viewing zone Vj, which has parallax to the pixel 308. However, due to distortion, the content of the pixel 308′ is still displaying the content belonging to the viewing zone Vi, causing defect for the stereo vision effect.

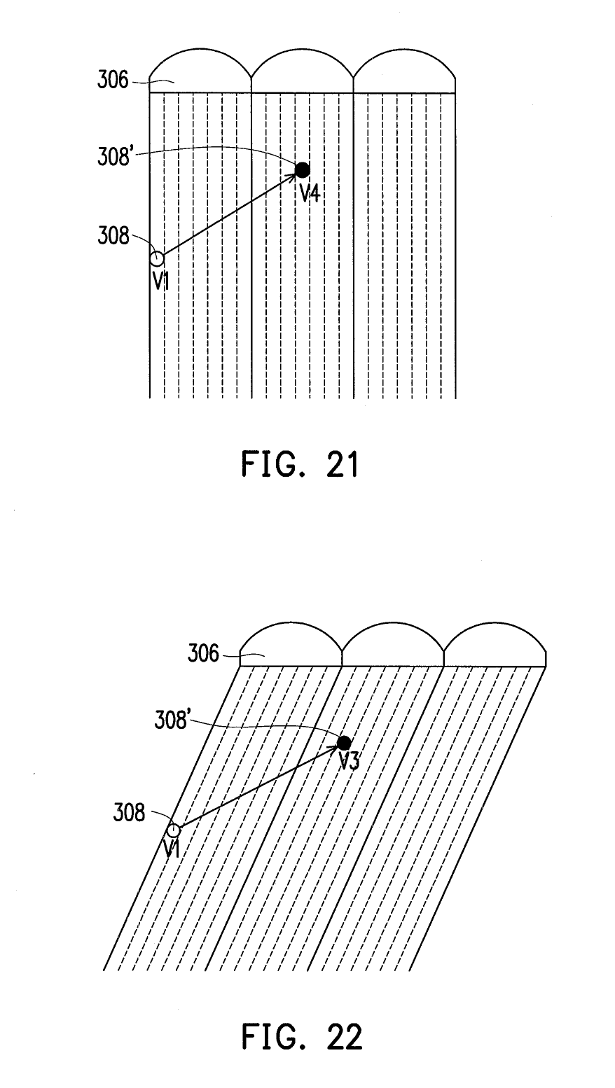

FIG. 21 is a drawing, schematically illustrating a distortion effect between pixel locations on the lenticular plate and viewing zones, according to an exemplary embodiment. In FIG. 20 as a further example, from the planar view on the lenticular plate, the pixel 308 belonging to viewing zone V1 is distorted to the location of pixel 308′, which is supposed to display the image content of viewing zone V4.

FIG. 22 is a drawing, schematically illustrating a distortion effect between pixel locations on the lenticular plate and viewing zones at a plane view, according to an exemplary embodiment. If the lenticular plate 306 is taking the structure with slanted structure as shown in FIG. 12 in an example, the pixel 308 may be distorted to the location of pixel 308′, which is supposed to display the image content of viewing zone V3.

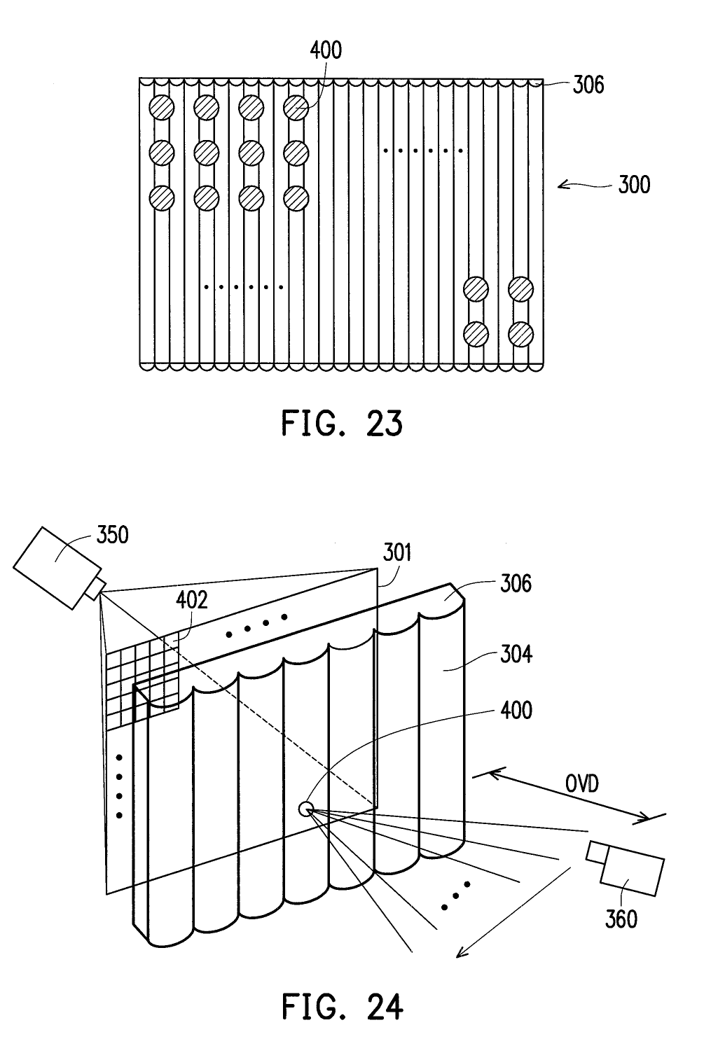

FIG. 23 is a drawing, schematically illustrating a sampling array on the screen for detecting viewing-zone shift, according to an exemplary embodiment. In FIG. 23, the viewing zone modulating screen 300 include the lenticular plate 306, facing to eyes of an observer. To detect the viewing shift for each pixel, one manner is detecting pixel by pixel. However, this way would cost much time and the work. After further investigation on the distortion, it can be found that the viewing zone shift is smoothly changing. So, it may be not necessary to detect each pixel. Therefore, several sampling points 400 as a sampling array can be taken for detecting the viewing zone shift in another manner. Then, the viewing zone shift for each pixel can be obtained by interpolation from the neighbour sampling points 400. To keep the precision for the viewing zone shift, a horizontal gap between adjacent sampling points may be not more than ¼ of a full horizontal width of the viewing zone modulating screen, and a vertical gap may be not more than ¼ of a full perpendicular width of the viewing zone modulating screen.

FIG. 24 is a perspective drawing, schematically a mechanism for detecting the viewing-zone shift, according to an exemplary embodiment. In FIG. 24, a luminance meter 360, located at the optimal viewing distance, OVD, from the lenticular plate 306 of the screen 300. The lenticular plate 306 is composed of a plurality of cylindrical lenses 304 aligned in parallel. The projection module 350 projects a sample image 301 onto the lenticular plate 306 with respect to the cylindrical lenses 304. For each sampling point 400, the luminance meter 360 moves at a horizontal direction as indicated by arrow with respect to the sampling point 400, with its optical axis always pointing to the same sampling point 400, across all of the viewing zones, for example. The luminance meter 360 measures the luminance at each movement. The result will be described in FIG. 26 as to be described later.

After the measurement for one sampling point 400, the luminance meter 360 goes to the next sampling points 400. As a result, each sampling point is measured for estimating the viewing zone shift.

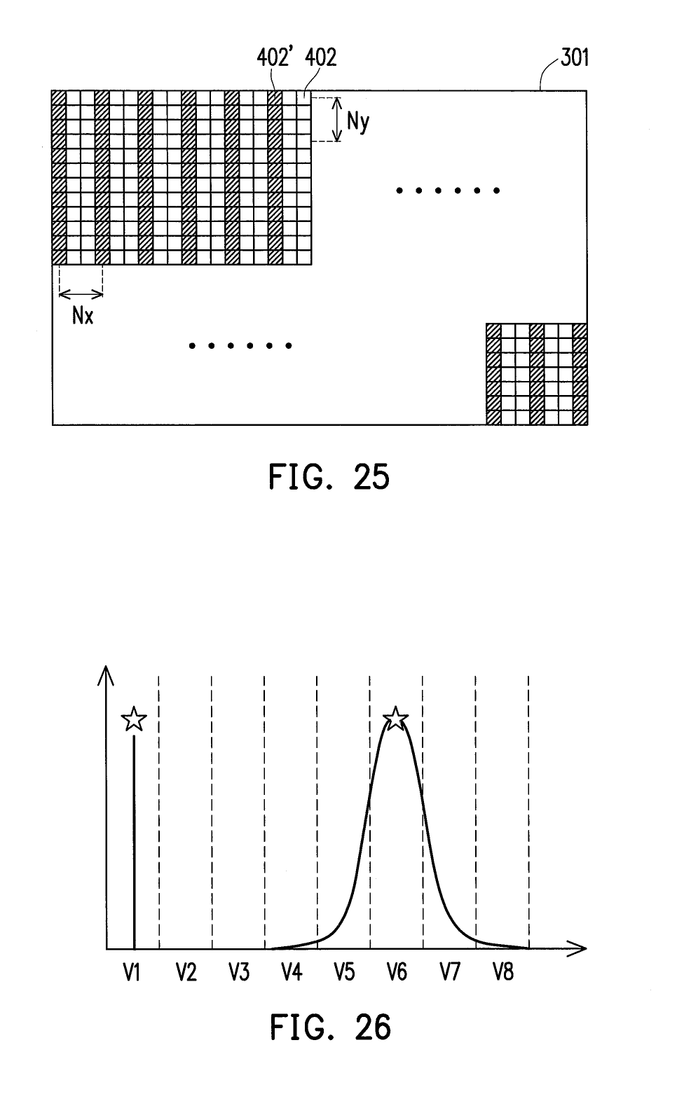

FIG. 25 is a drawing, schematically illustrating a sample image for detecting the viewing-zone shift, according to an exemplary embodiment. In FIG. 25, the sample image 301 is an image with the pixels 402′ belonging to the same viewing zone, e.g. V1, displaying the same color and the other pixels 402 may be turned off. In other words, it may not be necessary to display at all pixels. Instead, only some pixels 402′ for a part of pixel columns are displayed. The gap between adjacent two display pixels 402′ in pixel columns at horizontal direction may be a distance by Nx pixels. Further in an example, it may have only some pixels 402′ in same one pixel column been turned on, and the gap between adjacent two display pixels 402′ at vertical direction may be a distance by Ny pixels. The sample image 301 with known viewing zone can be taken as the reference to estimate the viewing zone shift.

FIG. 26 is a drawing, schematically illustrating a result on a sampling point with the viewing-zone shift, according to an exemplary embodiment. In FIG. 26, the measured result in FIG. 24 for one measured sampling point 400 can be seen. For example, the sample image is belonging to the viewing zone V1. For the sampling point be detected by the luminance meter 360 may have distribution of luminance with respect to the locations of viewing zones V1, V2, . . . , V8, for example. In this example, the peak of the distribution is located at the viewing zone V6, as determined by any proper statistic way, such as finding the peak or taking average. For the sampling point shown in FIG. 26, it can be recorded that this sample point has the viewing zone shift by shifting five viewing zones counting from viewing zone V1 to viewing zone V6. Fractional number of viewing zones shift can also be calculated by this method. This also implies that this sampling point should display the content belonging to the viewing zone V6 instead of displaying the content of the viewing zone V1. After all sampling points are measured and estimated, a viewing-zone shifting information can built up for later use.

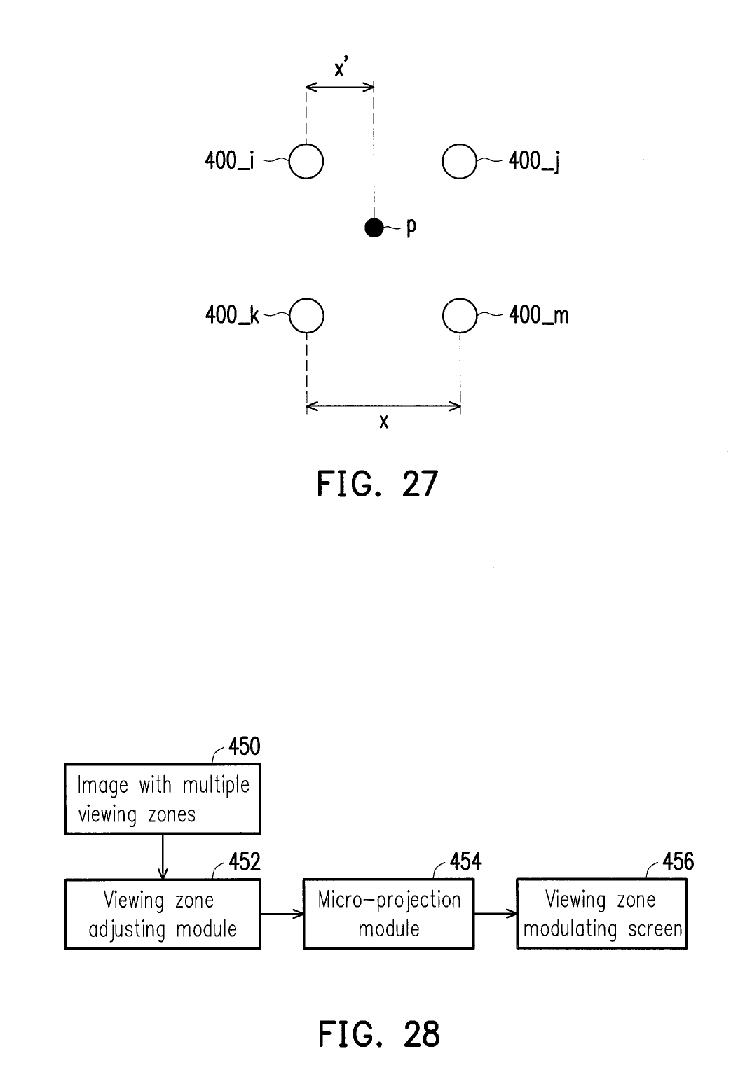

FIG. 27 is a drawing, schematically illustrating estimation of viewing-zone shift for the pixel based on interpolation from the sampling point, according to an exemplary embodiment. In FIG. 27, the sampling points does not include all of the pixels and even not precisely match to the pixels, the viewing zone shift for each pixel P can be estimated by interpolation from adjacent four sampling points 400_{—}i, 400_{—}j, 400_{—}k, and 400_{—}m. Assuming that the pixel P is distant from the sampling point 400_{—}i in horizontal direction by x′ and the full distance between the two sampling points 400_{—}i and 400_{—}j is x. The four sampling points 400_{—}i, 400_{—}j, 400_{—}k, and 400_{—}m respectively have the viewing zone shifts ^{Δ}Vi, ^{Δ}Vi, ^{Δ}Vk, and ^{Δ}Vm, as estimated by the example in FIGS. 22-26. In an example of the interpolation, the vertical adjacent two sampling points 400_{—}i and 400_{—}k can be averaged as (ΔVi+ΔVk)/2. Likewise, the vertical adjacent two sampling points 400_{—}j and 400_{—}m can be averaged as (ΔVj+ΔVm)/2. So, the viewing zone shift for the pixel P is ΔVp, obtained by Eq. 1.

ΔVp=(x′/x)(ΔVi+ΔVk)/2+((x−x′)/x)(ΔVj+ΔVm)/. (1)

However, the interpolation for the vertical direction can also be further included. Particularly, if the pixel P is for example located on the horizontal line on sampling points 400_{—}i and 400_{—}j or on the perpendicular line on sampling points 400_{—}i and 400_{—}k, the estimation can be simplified without averaged. Even further, if the pixel P is located on the sampling point, then the estimated viewing zone shift on the sampling point can be directly taken. In other words, the estimation of viewing zone shift for each pixel is not limited to the foregoing examples.

After interpolation, the viewing-zone shifting information includes the viewing zone shift ΔVp for each pixel. In considering the resolution of the viewing zones, the viewing zone shift ΔVp can be rounded into an integer in an example. The viewing-zone shifting information can be stored in a viewing zone adjusting module for modifying the content of pixel with the proper viewing zone.

FIG. 28 is a drawing, schematically illustrating a projection display unit with lens correction, according to an exemplary embodiment. In FIG. 28, a projection display unit is to display an image 450, which includes a plurality of viewing-zone images corresponding to a plurality of viewing zones. The image 450 is produced in the autostereoscopic displaying unit. The autostereoscopic displaying unit also includes a viewing zone adjusting module 452 for adjusting a content of each pixel of the image 450 corresponding to a determined one of the viewing zones according to a viewing-zone shifting information as previously described. The viewing-zone shifting information includes a viewing-zone correction for distortion of a projection lens and is implemented in the viewing zone adjusting module 452, which can be a software module or a hardware module for adjusting the viewing zone of the pixels. The image 450 is then modified as an adjusted image with viewing zone correction. A projection module 454, such as micro-projection module with the projection lens, projects the adjusted image. A viewing zone modulating screen 456 receives and displays the adjusted image.

As can be noted, a projection display unit may project a full content of the image. However as intended in FIG. 2 as the exemplary embodiment, an autostereoscopic display system may comprise a plurality of autostereoscopic displaying units. Each of the autostereoscopic displaying units is displaying the adjusted image as a sectional image of a complete image, and the autostereoscopic displaying units are joined to display the complete image. In this situation for an example, all of the viewing zone modulating screens of the autostereoscopic displaying units can be integrated as a single screen.

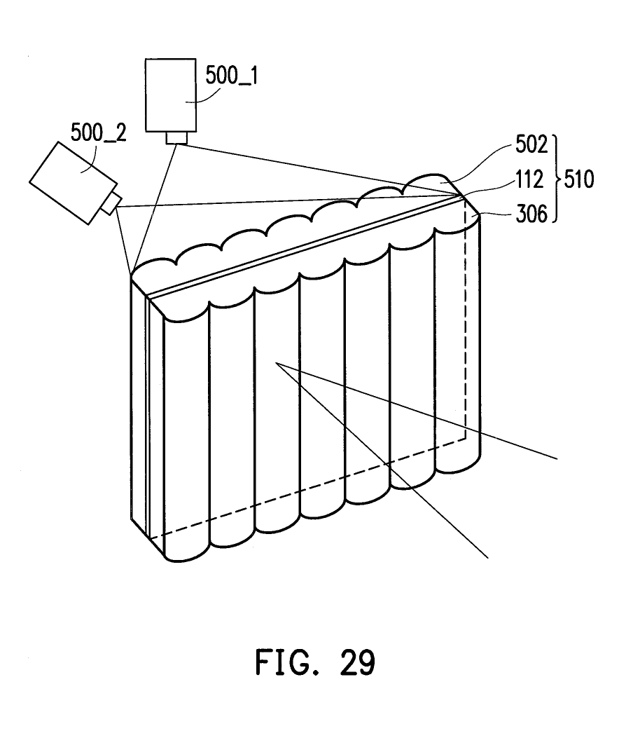

FIG. 29 is a drawing, schematically illustrating a sectional projection display unit, according to an exemplary embodiment. In FIG. 29, another exemplary embodiment can reduce the effect of image distortion due to the projection lens. The sectional projection display unit, for displaying a sectional image, includes a group of the micro-projection modules 500_1, 500_2, respectively projecting a group of viewing-zone images corresponding to a plurality of viewing angles on to the sectional part viewing zone modulating screen 510. A plurality of the sectional projection display units is combined to form a full system. The viewing zone modulating screen 510 receives and displays the viewing-zone images corresponding to the viewing angles. The viewing zone modulating screen 510 comprises a first lenticular plate 502, a second lenticular plate 306, and an imaging layer 112 (for example, a light diffusing layer) between the first lenticular plate 502 and the second lenticular plate 306.

The imaging layer 112 (for example, a light diffusing layer) and the second lenticular plate 306 functions as previously described. The second lenticular plate 306 deflects the viewing-zone images onto the specific viewing angles. However, the first lenticular plate 502 focuses and aligns pixels of the viewing-zone images onto the imaging layer 112 (for example, a light diffusing layer) with respect to the second lenticular plate 306. The cylindrical lenses of the first lenticular plate 502 respectively focus the image light to be perpendicular to the image layer 112, as an example. So, the distortion due to projection lens has been reduced or avoided by the first lenticular plate 502, in which the pixels after the first lenticular plate 502 are located at the required locations with respect to the cylindrical lenses of the second lenticular plate 306. The viewing zone for each pixel is at the correct one as expected.

In an example of the structure, the first lenticular plate 502 has a plurality of first cylindrical lenses and the second lenticular plate 306 has a plurality of second cylindrical lenses, the first cylindrical lenses are aligned to the second cylindrical lenses, and each of the cylindrical lenses respectively simultaneously receives the viewing-zone images.

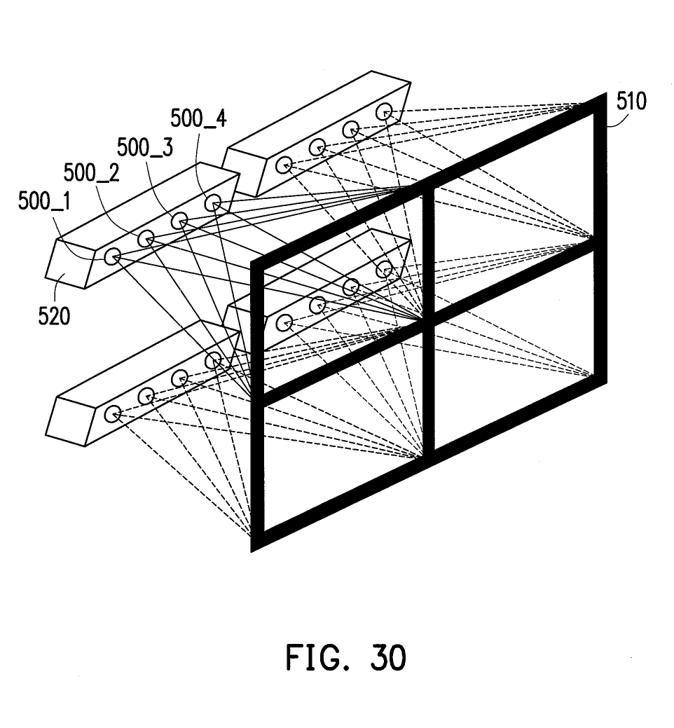

FIG. 30 is a drawing, schematically illustrating a projection display system, to form a larger screen size, according to an exemplary embodiment. In FIG. 30, for forming the larger screen with a larger image, an autostereoscopic display system can be set up. The autostereoscopic display system comprises a plurality of autostereoscopic display units 520, such as four units. Each of the autostereoscopic display units 520 has a group of projection modules, such as four projection modules 500_1, 500_2, 500_3, and 500_4, to respective project one sectional image at a specific viewing zone, as described in FIG. 29. In this example, four projection modules form a group of sectional images. Four autostereoscopic displaying units 520 are to project the group of four sectional images with respect to four viewing zones. In other words, each of the autostereoscopic displaying units 520 is displaying a group of the viewing-zone images to form a group of sectional image. Multiple groups of sectional images are joined as a complete image. The autostereoscopic displaying units 520 are to display the complete image. In this manner, the viewing zone modulating screens 510 of the autostereoscopic displaying units 520 can be integrated as a single screen.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An autostereoscopic displaying unit for displaying an image, wherein the image includes a plurality of viewing-zone images corresponding to a plurality of viewing zones, the autostereoscopic displaying unit comprising:
a viewing zone adjusting module, adjusting a content of each pixel of the image corresponding to a determined one of the viewing zones according to a viewing-zone shifting information, wherein the viewing-zone shifting information includes a viewing-zone correction for distortion of a projection lens, and the image is then modified as an adjusted image;
a projection module with the projection lens, projecting the adjusted image; and
a viewing zone modulating screen, receiving and displaying the adjusted image.

2. The autostereoscopic displaying unit of claim 1, wherein the viewing zone modulating screen has a horizontal reference direction and the adjusted image being projected has a rotating angle with respect to the horizontal reference direction.

3. The autostereoscopic displaying unit of claim 1, wherein the viewing zone modulating screen comprises a diffusion layer and a viewing zone modulating layer, the viewing zone modulating layer deflects an image light of the viewing-zone images into a predetermined direction.

4. The autostereoscopic displaying unit of claim 1, wherein the viewing-zone shifting information includes a plurality of sampling points formed as a sampling array, each of the sampling points has a reference viewing-zone shift and a viewing zone shift for each pixel is determined by interpolation from the adjacent sampling points.

5. The autostereoscopic displaying unit of claim 4, wherein the sampling points has a horizontal gap not more than ¼ of a full horizontal width of the viewing zone modulating screen, and a vertical gap not more than ¼ of a full perpendicular width of the viewing zone modulating screen.

6. The autostereoscopic displaying unit of claim 4, wherein the reference viewing-zone shift for each sampling point is a pre-measured value from a sample image, implemented in the viewing zone adjusting module.

7. An autostereoscopic display system, comprising a plurality of autostereoscopic displaying units as each recited in claim 1, wherein each of the autostereoscopic displaying units is displaying the adjusted image as a sectional image of a complete image, and the autostereoscopic displaying units are joined to display the complete image.

8. The autostereoscopic displaying system of claim 7, wherein all of the viewing zone modulating screens of the autostereoscopic displaying units are integrated as a single screen.

9. An autostereoscopic displaying unit for displaying an image, comprising:
a group of the micro-projection modules, respectively projecting a group of viewing-zone images corresponding to a plurality of viewing angles; and
a viewing zone modulating screen, receiving and displaying the viewing-zone images corresponding to the viewing angles, wherein the viewing zone modulating screen comprises:
a first lenticular plate;
a second lenticular plate; and
an imaging layer between the first lenticular plate and the second lenticular plate,
wherein the first lenticular plate focuses and aligns pixels of the viewing-zone images onto the imaging layer with respect to the second lenticular plate, and the second lenticular plate deflects the viewing-zone images onto the specific viewing angles.

10. The autostereoscopic displaying unit of claim 9, wherein the first lenticular plate has a plurality of first cylindrical lenses and the second lenticular plate has a plurality of second cylindrical lenses, the first cylindrical lenses are aligned to the second cylindrical lenses, and each of the cylindrical lenses respectively simultaneously receives the viewing-zone images.

11. An autostereoscopic display system, comprising a plurality of autostereoscopic displaying units as each recited in claim 9, wherein each of the autostereoscopic displaying units is displaying the group of the viewing-zone images referred as a sectional image group, all of the sectional image groups form a complete image, and the autostereoscopic displaying units are joined to display the complete image.

12. The autostereoscopic displaying system of claim 11, wherein all of the viewing zone modulating screens of the autostereoscopic displaying units are integrated as a single screen.
